(19) United States
(12) Patent Application Publication
(10) Pub. No.: US 2009/0174407 A1
(43) Pub. Date: Jul. 9, 2009

(54) CRYOGENIC COOLING OF MRI/NMR COILS USING INTEGRATED MICROFLUIDIC CHANNELS

(75) Inventors: Arum Han, College Station, TX (US); Steven M. Wright, College Station, TX (US)

Correspondence Address: CHALKER FLORES, LLP, 2711 LBJ FRWY, Suite 1036, DALLAS, TX, 75234, US

(73) Assignee: THE TEXAS A&M UNIVERSITY SYSTEM, College Station, TX (US)

(21) Appl. No.: 12/350,075

(22) Filed: Jan. 7, 2009

Related U.S. Application Data
(60) Provisional application No. 61/019,452, filed on Jan. 7, 2008.

(51) Int. Cl. G01V 3/00; H01F 7/00

(52) U.S. Cl. 324/318; 335/296

(57) ABSTRACT

The present invention includes an assembly with a magnet for magnetic resonance having a substrate with an imaging surface and an opening within the substrate adjacent the imaging surface. The present invention enhances the sensitivity and reduces the acquisition time of magnetic resonance imaging (MRI) and nuclear magnetic resonance (NMR) spectroscopy by cooling the coil using microfluidic channels through which a cryogenic fluid is pumped. Various embodiments have been detailed for clinical imaging or detection in which the integrated coil/microfluidic cryo-cooling system is outside the patient body or in vivo imaging or detection in which the integrated coil/microfluidic cryo-cooling system is inside the patient.

### CROSS-REFERENCE TO RELATED APPLICATIONS

This application claims priority to U.S. Provisional Application Ser. No. 61/019,452, filed Jan. 7, 2008, the entire contents of which are incorporated herein by reference.

### TECHNICAL FIELD OF THE INVENTION

The present invention relates in general to the field of thermal cooling of magnetic resonance imaging (MRI)/nuclear magnetic resonance (NMR) microcoils.

### STATEMENT OF FEDERALLY FUNDED RESEARCH

None.

### BACKGROUND OF THE INVENTION

Without limiting the scope of the invention, its background is described in connection with an apparatus and method for accomplishing heat transfer of magnetic resonance imaging/nuclear magnetic resonance (MRI/NMR) coils using microfluidic channels.

The use of liquid nitrogen or liquid helium to cool the coil has been previously suggested in MRI and NMR. Recently, the idea of using microfluidic channels for cooling has been developed, mostly for electronic component cooling.

For example, in U.S. Pat. No. 6,501,654, O'Connor, et al., described a microfluidic heat exchange system for cooling heat-generating components of electronic equipment, computers, lasers, analytical instruments, medical equipment and the like. Both direct contact and indirect contact microfluidic systems. Also described are microfluidic systems that incorporate remote heat rejection systems that may be located outside the body of the equipment that contains the heat generating components that need cooling.

Another example can be found in the U.S. Pat. No. 7,135,863 entitled “Thermal management system and method for MRI gradient coil”. In the '863 patent, Arik, et al., described a thermal management system and method for cooling Magnetic Resonance Imaging gradient coils. The system includes least one first header tube positioned adjacent to said gradient coils and configured to transport a coolant fluid; at least one set of cooling tubes connected to said header tube at inlet ends and configured to transport said coolant fluid, wherein said cooling tubes are parallel to each other and at least one second header tube positioned adjacent to said gradient coils, connected to said at least one set of cooling tubes at outlet ends of said at least one set of cooling tubes and configured to transport said coolant fluid.

Finally, in the U.S. Pat. No. 7,167,000, Amm, et al., described a cryogenically cooled radiofrequency (RF) coil structure for use in Magnetic Resonance Imaging (MRI) and method for cryogenically cooling RF coils. The cryogenically cooled RF coil structure comprises a sealed structure constructed of non-conducting material and adapted for containing a cooling substance and at least one RF coil disposed integrally in contact with the sealed structure such that sealed structure and integrally disposed RF coil are disposed about an object to be imaged.

However, most of the existing cooling method or apparatus do not have any means to localize cooling, hence affecting the temperature of not only the coil but also the target/sample areas. It would therefore be desirable to design an enhanced method and system for cooling in MRI/NMR that affects only the coil regions but not the target sample regions. The present inventors recognized the need and integrated microfluidic channels directly underneath or around the coil to achieve this localized cooling.

### SUMMARY OF THE INVENTION

The present invention is an assembly with a magnet (or coil) for magnetic resonance imaging having a substrate with an imaging surface and an opening within the substrate adjacent the imaging surface. In conventional MRI, the coils do not generate any heat, not like electronic equipments, mainly because the power used is very small, therefore, conventional coils run at room temperature. The present invention provides for cooling of the resonance source to improve the efficiency of coils, while maintaining subject comfort. The system has a magnetic resonance coil within the opening and opposite the imaging surface with a cryo-cooling via disposed within the substrate and below the magnetic resonance coil. Opposite the imaging surface, the via has an inlet and an outlet for a cryogenic fluid, wherein the cryogenic fluid cools the radiofrequency coil and the opening buffers the tissue target at or about the imaging surface from the small heat capacity of microscale cryogenic fluid channel directly cooling the radiofrequency coil. In one embodiment, the cryogenic fluid cools the radiofrequency coil but not the imaging surface.

In certain embodiments, the radiofrequency coils of the assembly are in the form of an array. In another embodiment, the substrate of the assembly has one or more sensors disposed within the vias and one or more valves, wherein the sensors detect the temperature as cryogenic fluid traverses the via and one or more processors open and close the valves depending on the temperature at the one or more sensors.

In another embodiment, the assembly of the present invention has at least one device layer of the substrate made out of, but are not limited to, a polymeric material, a urethane polymer, an acrylic polymer, a fluoropolymer, a silicone, a silicone gel, an epoxy, a polyamide, or a polyolefin, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), or polyvinylidene fluoride (PVDF), or any combinations thereof.

Yet in another embodiment, the substrate of the present invention is made out of, but are not limited to, sapphire (Al₂O₃), LaAlO₃, (La, Sr)(Al,Ta)O₃ (LSAT), MgO, AlN, aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, cereated glass, or any combinations thereof. In operation, the operating cryogenic fluid may contact, either directly or indirectly through a thin layer, at least a portion of the magnetic resonance coil.

In certain embodiments, the operating cryogenic fluid of the present invention contacts either directly or indirectly through a thin layer at least a portion of the magnetic resonance coil. The coils may be metal Cu, Nb or Nb compound such as NbTi or Nb₃Al, or lead alloy such as Pb or Pbln, or copper-oxide superconductor such as YBCO, or magnesium diboride (MgB₂)

In certain embodiments, the assembly of the present invention further has an enclosure disposed on or about the imaging surface, wherein the magnetic resonance coil is disposed substantially within the enclosure, and has one or more tubes that connect the vias to a cryogenic fluid tank. In another embodiment, at least one device layer is positioned between the substrate and the imaging surface, wherein the layer is a polymeric material having a low thermal conductivity to minimize the cold temperature from the cryogenic fluid reaching the imaging surface and affecting the imaging surface temperature. In one embodiment, the cryogenic fluid contacts either directly or indirectly through a thin layer at least a portion of the magnetic resonance coil.

In another embodiment, the assembly of the present invention has a pump that actively flows cryogenic fluid through the vias. In yet another embodiment, the assembly of the present invention is a magnetic resonance imaging apparatus with a plurality of a radiofrequency coil arrays.

The present invention also includes a magnetic resonance system. The magnetic resonance system includes a radiofrequency coil having a substrate comprising an imaging surface, an opening within the substrate adjacent the imaging surface, wherein this longitudinal opening is also being used to pump through gas-phase, root temperature cryogenic gas (e.g., helium, nitrogen or other gas) to prevent water condensation; a magnetic resonance coil array within the opening; and a cryo-cooling via disposed below magnetic resonance coil and the opposite the imaging surface, the via comprising an inlet and an outlet for a cryogenic fluid, wherein the cryogenic fluid cools the radiofrequency coil and the opening buffers the tissue target at or about the imaging surface from the heat generated by the radiofrequency coil and the cooling of the cryogenic fluid. In one aspect, the cryogenic fluid cools the coil but not the imaging surface.

The present invention also includes an MRI apparatus having a plurality of a radiofrequency coil arrays, each of the arrays having a substrate comprising an imaging surface, an opening within the substrate adjacent the imaging surface, an magnetic resonance coil within the opening; and a cryo-cooling via disposed adjacent the magnetic resonance coil and the opposite the imaging surface, the via comprising an inlet and an outlet for a cryogenic fluid, wherein the cryogenic fluid cools the radiofrequency coil and the opening buffers the tissue target at or about the imaging surface from the heat generated by the radiofrequency coil and the cooling of the cryogenic fluid.

In another embodiment the present invention also includes a method of generating a MRI image comprising: detecting a target image with an MRI apparatus comprising: a magnetic coil comprising: a substrate comprising an imaging surface, an opening within the substrate adjacent the imaging surface, an magnetic resonance coil within the opening; and a cryo-cooling via disposed below magnetic resonance coil and the opposite the imaging surface, the via comprising an inlet and an outlet for a cryogenic fluid, wherein the cryogenic fluid cools the radiofrequency coil and the opening buffers the tissue target at or about the imaging surface from the small heat capacity of microscale cryogenic fluid channel directly cooling the radiofrequency coil.

### BRIEF DESCRIPTION OF THE DRAWINGS

For a more complete understanding of the features and advantages of the present invention, reference is now made to the detailed description of the invention along with the accompanying figures and in which:

FIG. 1 is an illustration of the system showing the localized cryo-cooling principle with a cross section of the system shown at the bottom;

FIG. 2 is a plot of relative SNR vs. distance from coil plane for surface coils of varying diameter;

FIG. 3(a) is a plot of simulated result of the temperature profile when liquid nitrogen flows through the microfluidic cooling channel for one hour;

FIG. 3(b) is a plot of simulated temperature of the imaging surface and the MR microcoil;

FIGS. 4(a) and 4(b) are plots of simulated temperature profile when 10 parallel cooling channels were used on 10 parallel microcoil array;

FIG. 5 is a picture of planar pair element design fulfilling the need for phase encoding repetitions and the 64-element array coil;

FIG. 6 are pictures of three frames out of a series of 64, obtained at a rate of 200 frames/second using SEA imaging. Frames shown are frames 1, 10 and 20 following application of spin-tags for motion tracking;

FIG. 7 is an illustration of three microcoils with different combinations of trace thicknesses (Tr), number of turns and separations (Sp);

FIG. 8(a)-8(b) are plots of comparison of SNR vs. distance for three coils in FIG. 8. SNR numbers are normalized to the SNR from a single turn coil, 1 cm on a side. Excellent agreement is seen between theoretical results (8(a)) and reduced to practice results (8(b));

FIG. 9 is an illustration of a three coil array;

FIGS. 10(a) and 10(b) are images of a 14 mm I.D. test tube filled with tap water. A 2 mm O.D. teflon tube inside the test tube can be seen in both images. FIG. 10(a) is a composite image formed by combining three images obtained from each 6 mm diameter element of the three coil array illustrated in FIG. 12. TR=1000 ms, TE=20, 1 acquisition, 256×256 matrix, 28 mm field of view. Both images were obtained from a 1.0 T Siemens scanner. FIG. 10(b) is an image obtained with a saddle coil used for both excitation and receive;

FIG. 11(a) is an isometric illustration of the cryo-cooling/surface coil system; and 11(b) is a top view of the same. The liquid nitrogen cooling channel is embedded underneath the MR surface coil;

FIG. 12(a)-12(f) are illustrations of fabrication steps for the proposed system. FIG. 12(a) is an epoxy mold fabrication on silicon using photolithography; 12(b) PDMS casting for cooling channel; 12(c) PDMS release; 12(d) PDMS bonding to create an encapsulated channel; 12(e) Electrode fabrication through photolithography and electroplating; 12(f) PDMS casting and bonding of the imaging surface on top of the electrodes with an air gap;

FIG. 13 is an illustration of parallel imaging/cooling system utilizing 16 surface coil arrays and 16 microfluidic cryo-cooling channels; and

FIG. 14 is a table show shows variations for use with the present invention, including coil type, parameters that may be varied and an illustraion of coil onfigurations.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “microfluidic” as used herein is to be understood, without any restriction thereto, to refer to structures or devices through which fluid(s) are capable of being passed or directed, wherein one or more of the dimensions is less than 500 microns. Microfluidic devices according to the present invention typically comprise channels, chambers, and/or reservoirs containing fluids for accomplishing heat transfer.

As used herein, the terms “channel” and “chamber” as used herein is to be interpreted in a broad sense. Thus, they are not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete amount of fluid for a specified amount of time. “Channels” or “chambers” may be filled or may contain internal structures comprising valves or equivalent components.

As used herein, the term “substrate,” is defined as an underlying layer and the surface on which a material is deposited. The substrate may be partially transparent substance including glass, plastic, polymer, quartz or combinations thereof. The substrate may include one or more bioactive agents, biodegradable, electrically conductive, thermally conductive, porous, stimulatable, or combinations thereof. The substrate may also be a polymeric material, e.g., a urethane polymer, an acrylic polymer, a fluoropolymer, a silicone, a silicone gel, an epoxy, a polyamide, or a polyolefin, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), or polyvinylidene fluoride (PVDF). In other embodiment, the substrate may be, e.g., aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, or cereated glass.

As used herein, the term “array,” is defined being place in an orderly arrangement this may include a rectangular, circular, oval, polygonal or similarly shaped arrangement of quantities in rows and columns, as in a matrix. The totaling members of the array are 2 or more e.g.,anarraymaybe 1 by 2, 1 by 3, 2 by 2, 2 by 3, 10 by 10, 50 by 50, 100 by 100, 200 by 200 and so on.

The use of microfluidics has seen a surge in varieties of applications during the past decade, such as for miniaturized chemical and biological analysis systems (“lab-on-a-chip”) [1-14], drug delivery devices [15-21], tissue engineering [22,23], miniaturized bioreactors [24-26], inkjet printing systems [27], combustion engines [28], and propulsion systems [29]. These applications utilize the unique characteristics of microfluidics, such as small volume and large surface to volume ratio. One application of microfluidics that utilizes these unique characteristics is in cooling, mainly for electrical circuits and components. Increased power consumption of more advanced and complex systems coupled with smaller system size causes serious thermal management issues [30]. For the systems to properly operate, large heat generation and reduction of available heat removal surface areas have to be managed through cooling. There are various cooling methods available that utilize microfabricated structures. Most of the cooling methods developed implement arrays of microfins fabricated at the surface of a system as a heat sink coupled with a cooling fan [31-33]. The use of microfins increases the surface area of a conventional heat sink, hence enhancing the efficiency of air cooling. Another air cooling method developed is to directly incorporate an active air cooling microstructure within a printed wiring board [34]. The active microstructure works as a synthetic air jet driver that drives heat carrier fluid through the fluidic passages to remove heat.

While these air cooling technologies show large improvements over conventional air cooling, liquid cooling can provide even higher improvement in heat flux. Many efforts have focused on developing miniaturized fluidic systems that can drive liquid-phase coolants through micrometer scale fluidic channels [35-39]. The high surface to volume ratio of microfluidic channels enhances heat dissipation through the coolant.

Although these miniaturized liquid cooling systems show significantly higher cooling efficiency over conventional systems, their main applications are for cooling heated electronic components or systems down to room temperature. This is significantly different from cryogenic cooling systems which are mainly used to cool components down to liquid nitrogen temperature for improved sensitivity and low noise. The use of liquid nitrogen or liquid helium to lower the temperature of MRI/NMR coils is being used to lower the resistivity of the coils, hence improving the signal to noise ratio (SNR) and acquisition time. There has been reports of developing micropumps for compact cryogenic cooling system for high-temperature superconducting systems or charged-coupled devices, but those systems are not applicable to cryo-cool MR (magnetic resonance) microcoils [40].

Cryogenic cooling of MR coils can significantly improve its sensitivity. When a microfluidic channel through which a cryogenic gas, e.g., liquid nitrogen or helium, can be pumped through is placed directly underneath a MR microcoil, the liquid nitrogen will cool the microcoil to liquid nitrogen temperature. When liquid nitrogen flows through a micrometer scale fluidic channel, the minute (nanoliter) volume of liquid nitrogen that can be carried through the microchannel is much smaller compared to a fluidic channel used in conventional cryostats. Due to the small heat capacity associated with the small volume of the microchannel, only the area directly adjacent to the microchannel, in this case the MR microcoils, will be cooled down to liquid nitrogen temperature (−196° C.).

This invention describes a method and apparatus for using a single microfluidic channel or arrays of microfluidic channels to cryo-cool a MRI/NMR coil or coil arrays without affecting the temperature of the target sample. Various embodiments are presented for clinical imaging or detection in which the integrated coil/microfluidic cryo-cooling system is outside the patient body or in vivo imaging or detection in which the integrated coil/microfluidic cryo-cooling system is inside the patient.

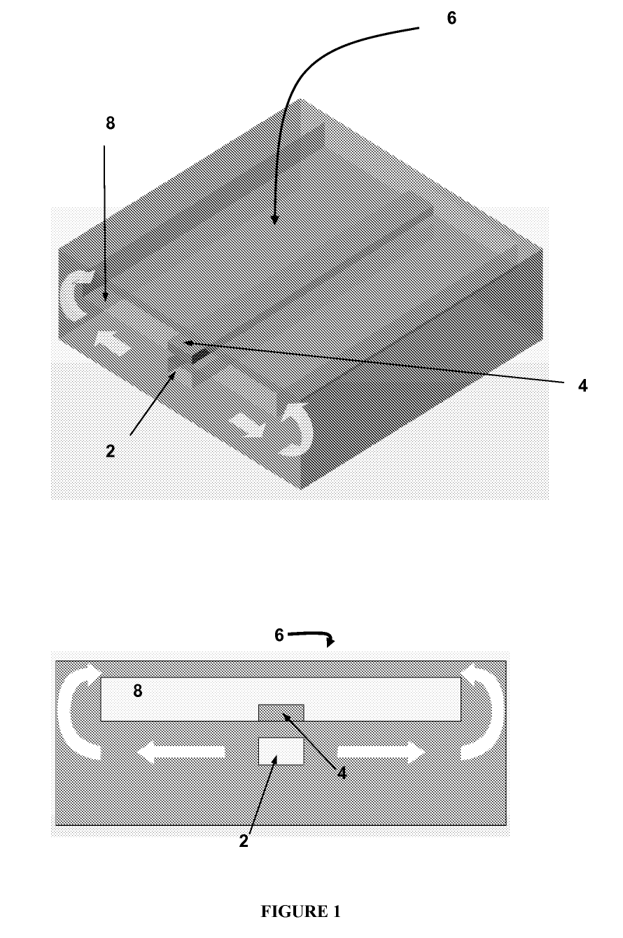

FIG. 1 illustrates an isometric cross-sectional view of one embodiment of the present invention as described above. In the present invention, by separating the imaging surface from the cryo-cooled microcoil by a thin air gap 8, the already localized cold energy has to travel all the way around and through the low heat-conducting substrate material, hence minimizing the temperature effect at the imaging surface. The integrated microfluidic cryo-cooling channel/coil system of the present invention has two main components; the coil and the microfluidic cryo-cooling channel.

As seen in FIG. 1, the microfluidic cryo-cooling channel 2 can be either fabricated separately and be attached to a conventional MRI/NMR coil or integrated into a microfabricated surface coil 4. The microfluidic cooling channels are the fluid path through which liquid nitrogen or liquid helium can be delivered for cryo-cooling of coils. The channel can be located either directly underneath the coils or surrounding the coils. The gap between the fluidic channel and the coil is minimized so that the coil can be cryo-cooled by liquid nitrogen running through the channel with minimum channel width and depth. The width and depth of a typical microfluidic channel can be in the range of micrometers to millimeters, with the channel length covering the length of the coil and the matching & tuning network to uniformly cryo-cool the entire region. The imaging surface 6 shown in FIG. 1, typically located on top of the coil, is separated by an air gap 8 or vacuum gap, being supported at the far edge of the imaging surface. This results in the cold temperature from the channel or coil to transfer only through the channel layer and the supporting block, but not directly to the imaging surface, other than through radiation. During the energy transfer through the long path from the cold channel or coil toward the imaging surface, most of the cold energy is dissipated so that the temperature target sample remains unaffected or that the effect is minimized.

It can be seen that the surface coil 4 is directly on top of the microfluidic cryo-cooling channel 2 for maximum cooling efficiency while the imaging surface 6 is located on top of the surface coil 4 separated by a thin air gap 8. The arrows indicate the heat path from the liquid nitrogen cooling channel. Using the microfluidic cryo-cooling system, no complicated vacuum cryostats are required and the distance between the imaging surface and the MR coils can be minimized for maximum sensitivity. Also, the fabrication of custom cryostats for various surface coil designs can be greatly simplified at low cost using microfabrication technologies. The use of flexible substrates in which microfluidic cryo-cooling channels can be built in enables cryo-cooling of non-planar surface coils that can be used for imaging curved biological samples.

In certain embodiments, the present invention can be expanded in the future to an array format for high-resolution real-time imaging of biological samples. Furthermore, it can be expanded to be used with high temperature superconducting (HTS) microcoils such as Y—Ba—Cu—O (YBCO) microcoils, which is almost seven (7) times more conductive then a copper at liquid nitrogen temperature [41].

MR Microcoils and Cryo-cooling. MRI is generally considered to be a signal-to-noise ratio (SNR) limited technique. For imaging small objects, it is important to optimize the SNR by using a “microcoil” optimized to the depth of interest. While in principle the use of microcoils can provide extremely high SNR over small regions, there are two very important limitations, both of which are the subject of this proposal: 1) Copper loss is the primary source of noise even in very small microcoils and can be minimized by cryo-cooling and 2) Even small increases in the separation between the coil and the sample can significantly degrade the SNR provided by microcoils. The microfluidic cryo-cooling technology proposed herein reduces copper loss without requiring bulky cryostats.

SNR from surface coils. The derivation of the SNR for a uniform sample is widely available [42,43] and are summarized here. Assuming a uniform phantom and a uniform field over the voxel, the peak signal becomes:

V_{signal}=ωVₛM_{xy}|B₁_{ₜ}| (1)

where ω=βₒ and Vₛ is the voxel size, assumed uniform. |B₁_{ₜ}| is the effective flux-density of the coil. The noise can be characterized by the resistance of the coil at the terminals, the effective temperature, ordinarily room temperature, and the receiver bandwidth.

Vₙₒᵢₛₑ=\sqrt{4kT Δf R} (2)

Thus, the signal-to-noise ratio, SNRₖ, of a Free Induction Decay (FID) or echo is the ratio of the peak detected signal voltage to the rms noise level:

$${SNR}_{k} = \frac{ω {V}_{s} {M}_{xy} \vert {B}_{{1}_{t}} \vert}{\sqrt{4 kT Δ fR}} \qquad ( 3 )$$

Of particular significance to this proposal is that the noise temperature and resistance in the denominator of equation 3 are effective values. In reality, the noise is due to a combination of sources. These include electrical and magnetic noise associated with the sample (sample loss), conduction losses in the coil (primarily finite conductivity in the conductors—copper loss) as well as radiation losses [42,44]. The latter might be best described as interaction with the environment other than the desired sample. Radiation loss can be minimized by proper coil design, and in the case of microcoils, is generally not a concern as radiation loss is proportional to the size of the coil to the fourth power [45].

$${SNR}_{k} = \frac{ω {V}_{s} {M}_{xy} \vert {B}_{{1}_{t}} \vert}{\sqrt{4 k Δ f ( {T}_{sample} {R}_{sample} + {T}_{coil} {R}_{coil} )}} \qquad ( 4 )$$

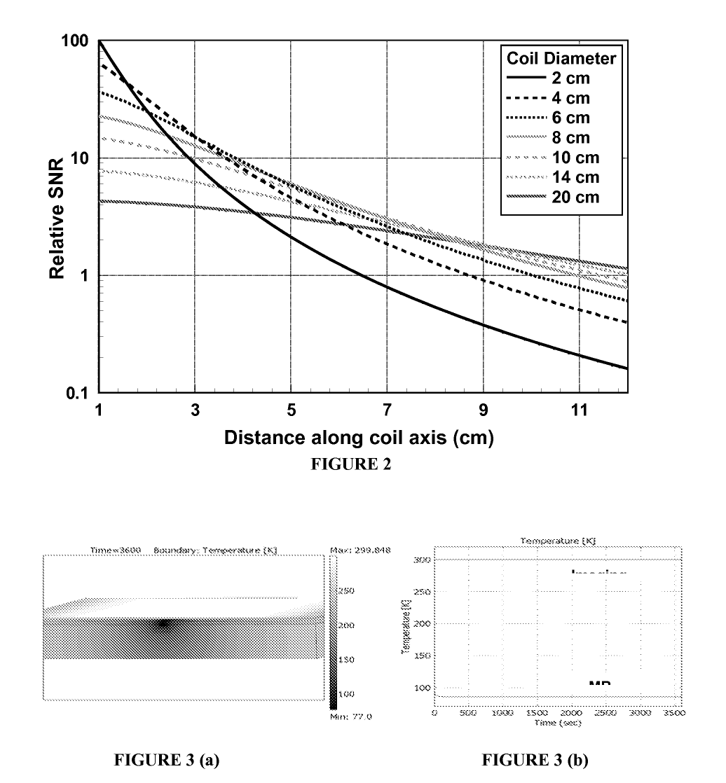

Importance of “thin” integrated cryostat technology. Equation 4 can be used to find the “optimal” coil diameter for a given distance into the sample (pixel location). FIG. 2 shows the SNR given by equation 4 as a function of distance from the coil and coil diameter, assuming sample noise dominance. FIG. 2 is a plot of relative SNR vs. distance from coil plane for surface coils of varying diameter. The optimal coil diameter is a function of imaging depth. It clearly shows that for a pixel close to the coil, the smaller coil provides significantly higher SNR than does a larger coil. The use of “microcoils” is of extreme interest due to the high SNR provided by matching the size of the coil to the field-of-view and depth of interest [44,46,47]. A second important fact that can be observed from FIG. 2 is that the sensitivity of a small coil drops off extremely rapidly. It is very important that small coils be located very close to the object under study. Small increases in the distance between the coil and the pixel can significantly degrade the SNR. The integrated cryostat technology does not require a bulky cryostat that reduces the sensitivity of the coil.

Effect of cryo-cooling on effective noise level. Cryogenically cooled copper or high-temperature superconducting (HTS) coils have been an active area of research in recent years [48-54]. Comparison of cryo-cooled and room-temperature coils is often complicated by a change in coil geometry necessary to accommodate a cryostat. Assuming the coil geometry, particularly the distance to the sample, does not change, the improvement in SNR obtained by cooling is determined purely by the noise levels, as shown in equation 5.

$$\begin{matrix}\frac{{SNR}_{cooled}}{{SNR}_{warm}} = \frac{\sqrt{4 k Δ f ( {T}_{sample} {R}_{sample} + {T}_{coil , warm} {R}_{coil , warm} )}}{\sqrt{4 k Δ f ( {T}_{sample} {R}_{sample} + {T}_{coil , cooled} {R}_{coil , cooled} )}} \\ \approx \sqrt{\frac{{T}_{sample} {R}_{sample} + {T}_{coil , warm} {R}_{coil , warm}}{{T}_{sample} {R}_{sample} + {T}_{coil , cooled} {R}_{coil , cooled}}}\end{matrix} \qquad ( 5 )$$

Two cases are of importance to consider. (1) Cooled coil becomes sample noise dominated, and (2) Cooled coil remains copper noise dominated. Case 1: If the temperature is dropped from room temperature to liquid nitrogen temperature and the room temperature sample noise contribution is equal or greater than the room temperature coil noise, then the second term in the denominator of equation 5 can be ignored. In this case the expected SNR ratio can be approximated as:

$$\frac{{SNR}_{cooled}}{{SNR}_{warm}} \approx \sqrt{1 + \frac{{R}_{coil , warm}}{{R}_{sample}}} \qquad ( 6 )$$

for the case of a patient loss dominated coil. Thus, if the sample noise is equal to the coil copper loss after cooling, one can expect at best an improvement of square root of two in SNR by cooling the coil.

Of more interest of the present invention is that where the coil remains copper loss dominated, as would be the case with very small coils such as used by Peck [44]. In this case, the second term is dominant in both the numerator and denominator of equation 5, giving:

$$\begin{matrix}\frac{{SNR}_{cooled}}{{SNR}_{warm}} = \frac{\sqrt{4 {kT}_{coil , warm} Δ f {R}_{coil , warm}}}{\sqrt{4 {kT}_{coil , cooled} Δ f {R}_{coil , cooled}}} \\ = \sqrt{\frac{{T}_{coil , warm} {R}_{coil , warm}}{{T}_{coil , cooled} {R}_{coil , cooled}}}\end{matrix} \qquad ( 7 )$$

Assuming that the temperature drops from 300 to 77 K and that the resistivity of copper drops 8 fold from 1.7×10⁻⁸ Ωm down to 0.2×10⁻⁸ Ωm over this range, this results in an improvement of a factor of over 5 in SNR. Since the SNR is proportional to the square root of the imaging time in MRI, this can reduce scan time by a factor of 25 with no loss in image quality, or, conversely, provide a factor of 5 improvement in SNR for a given embodiment as compared to using a un-cooled coil. These improvements will be even larger for HTS coils, however, in that case the loss mechanism does become sample loss dominated, in which case the smaller SNR gain given by equation 6 apply. Finally, it is important to reiterate that these SNR gains are obtained only in the case where the distance between the coil and the sample are not increased by a cryostat. It if for this reason that cryo-cooling is generally applied to larger coils, where the cryostat thickness is less significant.

Conventional cryostats are used to improve coil sensitivity by cooling the copper coil to liquid nitrogen temperature (−196° C.) but require a thick insulating layer between the coil and the sample to maintain room temperature at the imaging surface. The thickness of this insulating layer makes conventional cryostats not suitable for surface coils.

In the present invention, the developed system/apparatus incorporates microfluidic cryo-cooling channels directly underneath the surface coils to cool the coils to liquid nitrogen temperature without affecting the temperature of the biological samples to be imaged. The minute (nanoliter) volume of liquid nitrogen in the microchannel localizes the cold temperature to the microcoil and the micrometer scale air gap between the coils and the samples can reduce the coil to sample distance significantly. Microfabrication technologies is used to build a compact and fully integrated cryo-cooling microfluidic channel/surface coil system, which were tested on previously published and tested microcoil configurations. The resulting system has an improvement of a factor 5 or more in signal-to-noise ratio (SNR) with a potential to reduce scan time by a factor of 25 with no loss in image quality. This enables the use of smaller surface coils for high-resolution imaging, where the use of smaller surface coils is typically limited due to its low sensitivity.

One of the primary goal of the present invention is to demonstrate a localized cryo-cooling system integrated with MRI surface coils for high-resolution imaging of biological samples. The miniaturized and localized cryogenic cooing system with integrated surface coils can be used for high-resolution imaging of biological samples. The key to this invention is that the microfabricated cryogenic cooling system can cool the Magnetic Resonance Imaging (MRI) surface coils to liquid nitrogen temperature without affecting the temperature at the imaging surface, while maintaining minimal distance between the coil and the target sample for maximum sensitivity.

The present invention also enables cryo-cooling of planar surface microcoils for high-resolution biological sample imaging without a thick conventional cryostat. The system enhances the sensitivity and reduces the acquisition time of magnetic resonance imaging (MRI) and nuclear magnetic resonance (NMR) spectroscopy by cooling the coil using microfluidic channels through which liquid nitrogen or liquid helium can be pumped through.

The novelty of this invention includes, but is not limited to: (1) the microfluidic cryo-cooling channels are integrated directly underneath or around the coils to locally cryo-cool the coils without affecting the temperature of target samples that are in close proximity of the coils; (2) the use of localized cryo-cooling using microfluidics and a thin insulating air or vacuum gap to minimize the distance between the coil and the imaging surface for maximum sensitivity; (3) the miniaturized and integrated coil/microfluidic cryo-cooling channel combination enables this invention to be used not only in vitro, but also in vivo; and (4) the capability to create arrays of coil/microfluidic cryo-cooling channel combination for parallel imaging and detection.

Simulation and fabrication of microfluidic channels for localized cryo-cooling. To demonstrate localized cryo-cooling of MR surface coils using microfluidic channels and its temperature effect on the imaging surface, numerical simulations on the design shown in FIG. 1 were conducted. The structure consists of a microfluidic channel through which liquid nitrogen can flow through, a surface coil electrode, and an integrated imaging surface on which target samples can be placed. A 100 μm wide, 50 μm deep microfluidic cooling channel was placed underneath a 100 μm wide, 30 μm high surface coil electrode, separated by a 100 μm thick channel capping layer. The built-in imaging surface above the surface coil electrode was separated from the electrode by a 100 μm air gap and supported from two side structures placed 500 μm away each side from the surface coil electrode. This structure was designed to effectively cool the electrode while minimizing the distance between the surface coil electrode and the imaging surface without affecting the temperature of the target sample by the cryo-cooling microfluidic channel. Polymers such as polydimethyl siloxane (PDMS) and poly(methyl methacrylate) (PMMA) were chosen as the structural material due to their low thermal conductivity and ease of microfabrication. Copper was chosen as the coil material, however, other materials may be used with the present invention.

Microfluidic channels built in materials with low thermal conductivity are best suited since it localizes cooling to the immediate surrounding of the channel without affecting the other areas, especially where the samples are located. Polymers are good candidate for channel and imaging surface materials (examples include, but are not limited to: PMMA, polycarbonate, PVC, cyclic olefin copolymer, polyimide or any combinations thereof) but other materials with low thermal conductivity can be used as well. Various microfabrication technologies, such as hot embossing, laser micromachining, soft lithography, and injection molding can be used but are not limited to for polymer channel fabrication. The open channel structure can be either bonded directly underneath a conventional coil, or bonded to a capping layer, on top of which coils can be built. The surface coil structure can be built using microfabrication technologies, such as photolithography, metal evaporation, and metal electroplating, but other microfabrication technologies can be used as well. Copper is a good material to be used as the coil material.

In order to test the microfluidic cooling concept, numerical simulations were conducted from a preliminary design. FIGS. 3(a) and 3(b) show simulated result of the temperature profile when liquid nitrogen flows through the microfluidic cooling channel. FIG. 3(a) shows the temperature of cooling channel at −196° C. (77 K) and the temperature of the surrounding area increasing rapidly toward room temperature of 25° C. (300 K). It can be seen that the imaging surface remained at room temperature even after one hour of cryo-cooling due to the small volume of liquid nitrogen carried through the microfluidic channel. Also, most of the cold energy has to travel all the way around through the side support structure to reach the imaging surface, due to the thin 100 μm air gap between the imaging surface and the electrode. The simulated result shows that radiation of the cold energy through the air gap does not affect the temperature at the imaging surface. FIG. 3(b) shows the temperature of the electrode and the imaging surface during one hour of liquid nitrogen cooling. It can be seen that the temperature at the surface coil electrode drops almost immediately to around −193° C. (80 K) while the temperature at the imaging surface remains at room temperature even after 1 hour of cryo-cooling. The temperature of the coil region drops within 100 seconds to steady state while the temperature of the sample region is maintained at room temperature even after one hour of cryo-cooling.

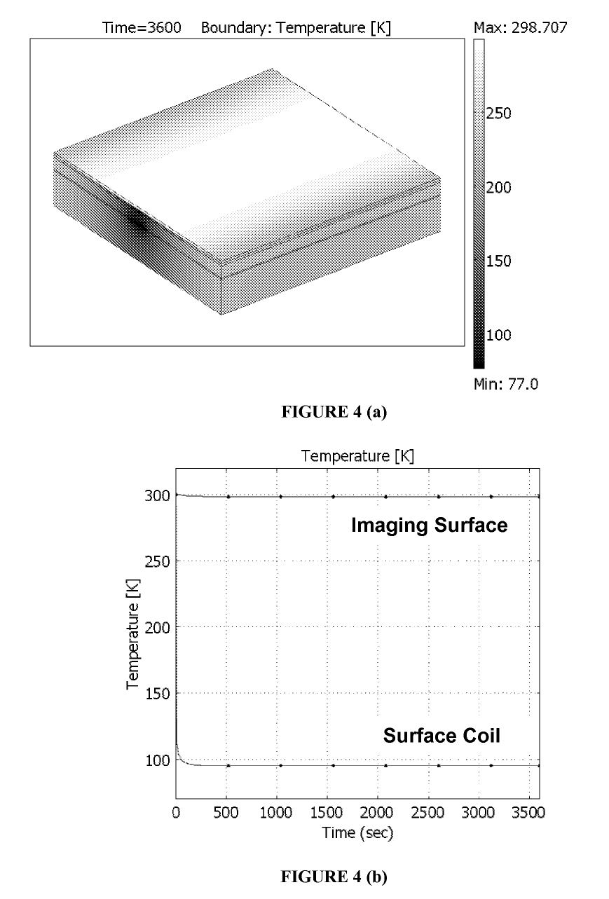

Simulation may also be conducted on 10 parallel surface coil arrays and cryo-cooling channel arrays showing similar temperature profile as the single electrode/single cooling channel structure (FIG. 4(a) and FIG. 4(b)). The simulation was conducted using a commercial fluidic/heat simulation software Comsol Multiphysics™ (Comsol, Inc., USA).

Temperature characterization using a thermocouple is currently being conducted while pumping liquid nitrogen through the fabricated cooling channels. Liquid nitrogen was successfully pumped through the microfluidic channel in liquid phase and a drop in temperature at the surface coil may be observed.

RF Microcoils. As the coil dimensions are reduced, the relative contribution of the copper loss to the sample loss increases. At 4.7 Tesla, even the relatively large array elements (8 cm long and 2 mm wide) for Single Echo Acquisition (SEA) imaging are primarily copper loss dominated [64]. Unfortunately, conventional cryostat technology is not useful, as the thickness of the cryostat would offset the SNR gain of the cooling, as discussed above. The integrated cryo-cooling discussed in the present invention is a highly significant technology that improves the SNR in SEA imaging.

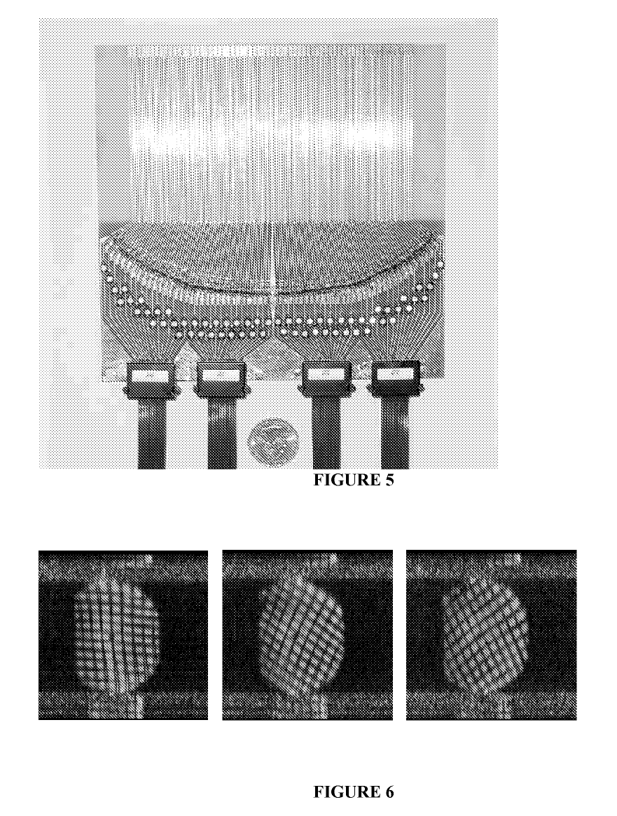

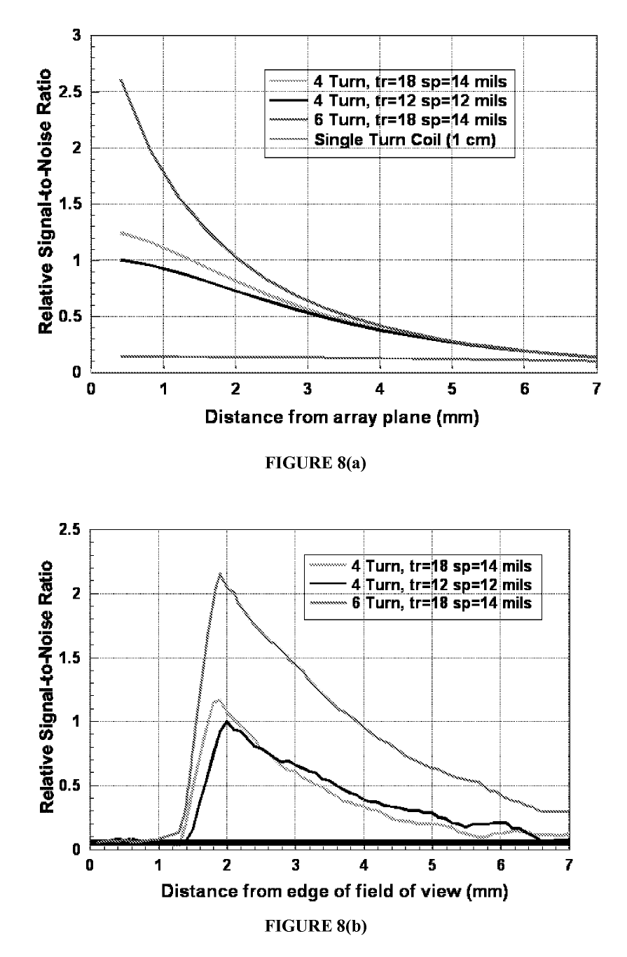

Scan time improvement with microcoils. In Single Echo Acquisition (SEA), slice selection and frequency encoding are performed using standard gradient methods, with the frequency encoding along the long axis of the array elements and slice selection in the coronal plane, parallel to the array. The phase encoding is eliminated and replaced by the spatial localization provided by Nₚ narrow, parallel and closely-spaced array elements, as shown in FIG. 5 [64,65]. Using a 64-channel receiver constructed, the signals from each of the 64 coils are simultaneously received and digitized. A 1-D FFT is performed on the echo received from each coil, the resulting 64 images stacked into a 64×N_{f} matrix, and the matrix interpolated to N_{f}×N_{f} for display. As an example of the technique, FIG. 6 shows three SEA images extracted from a 200 frame/second movie series in which spin-tags are applied and then followed as the object rotates [66]. The spin-tags are applied using Dante pulse trains in orthogonal directions, each taking approximately 14 msec. to apply. Following application of the tags, a series of gradient echo images, TR/TE=5/3 msec with 128×64 resolution are acquired, one per TE, obtaining 200 frames/second. The three images shown in FIG. 6 are frames 1, 10 and 20, and clearly illustrate the rotation of the object. The objective of this work is to develop an extremely rapid and robust imaging method that is capable of capturing turbulent or chaotic flow or other non-repetitive events. Each coil element in the array of FIG. 8 is 8 cm long and 2 mm wide and is coil noise (copper loss) dominated. Cryo-cooling these elements with the technology proposed here would significantly improve the performance of this new imaging method.

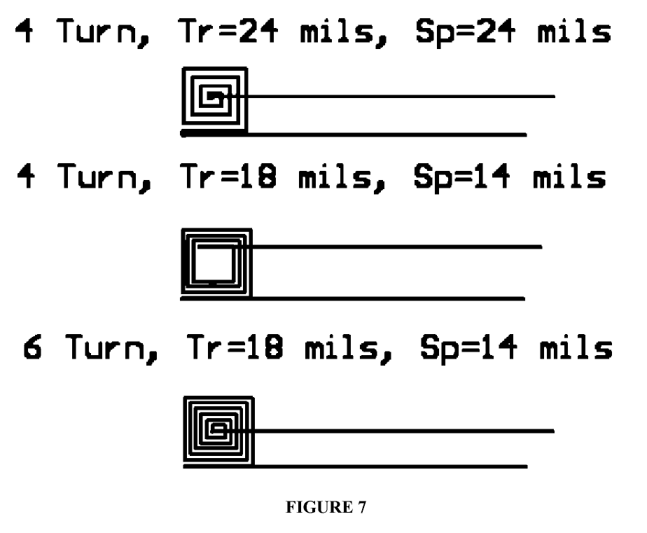

SNR improvement with microcoils. Unlike coils that are sample loss dominated, the design and optimization of copper-loss dominated microcoils is complex because of the many degrees of freedom in the coil design process. With sample loss dominated coils, adding turns or changing conductor thickness has relatively little effect on the coil performance as long as it remains sample loss dominated. Others have performed a number of studies on planar coils [44,67-71]. The present inventors have performed similar demonstrations in order to show favorable designs for building microcoil arrays [72,73]. As an example, following a relatively exhaustive search of the parameter space for a 1 cm per side square microcoil, three possible coil designs were modeled and constructed in order to validate in-house developed design software tools. The three coils are illustrated in FIG. 7. Theoretical (FIG. 8(a)) and measured (FIG. 8(b)) results of the SNR obtained from an image in a uniform phantom as a function of distance from the elements are shown in FIG. 8. Both the theoretical and demonstrated results indicate that the 6 turn coil outperformed either of the 4 turn coils at both shallow and deep locations. These results were obtained at 2.0 Tesla, where each coil was substantially copper loss dominated. Cryo-cooling could be expected to improve the SNR by approximately a factor of 5 or more.

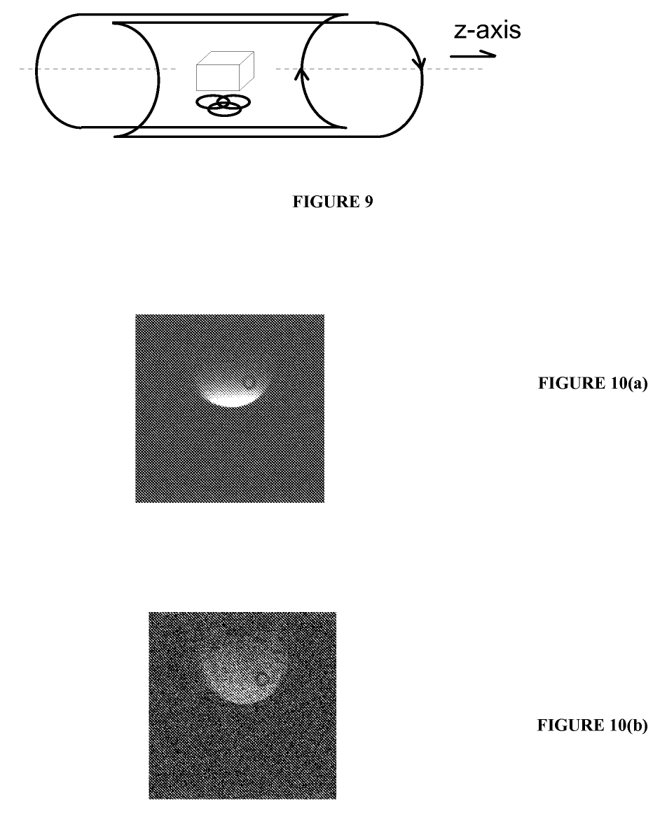

As an example of the potential application of microcoils, a demonstration was done where an array of three 6 mm outer diameter surface coils were used to image a small phantom. The array was placed inside a custom gradient set and a volume coil was used for excitation, as illustrated in FIG. 9. Images were collected simultaneously from the volume coil and the three microcoils. The three surface coil images were combined using a “sum-of-squares” combination, giving the image shown in FIG. 10(a). For comparison, the image from the volume coil, which was just large enough to encompass the coil array and the phantom, is shown in FIG. 10(b). The microcoil array provided a significantly improved SNR, despite the fact that each coil element was copper loss dominated at 1.0 Tesla.

Development of an integrated cryo-cooling channel/surface coil system that enables localized cryo-cooling of surface coils while maintaining room temperature at the imaging surface. An integrated microfluidic cryo-cooling/surface coil system composed of a polymer microfluidic cryo-cooling channel, a copper surface coil, and an imaging surface were developed using microfabrication technologies.

The various dimensions of the surface coils described here were based on the optimized modeling result. Also, all the surface coils with integrated cryo-cooling microchannels described in this section were fabricated both with the cooling channel and without the cooling channel so that the surface coils without the cooling channels can be tested in parallel for reference data and coil optimization.

Microfabrication of integrated cryo-cooling channel/surface coil system. The system has two main elements. The first one is incorporating heating coil around the sample region. This heating element has two purposes. When further minimizing the size of the system, the heat path will be also reduced, hence increasing the possibility of the cold temperature to reach the sample region. The cold energy can be compensated by adding a heating coil through which current can flow. The second function of this heating element is to maintain the temperature of the target sample at physiological temperature (37° C.). This is useful when the samples are of biological origin (e.g. live tissue, brain slices) where maintaining the temperature to physiological temperature ensures the viability of such sample. The heating elements can be also used when using the system in vivo. The second element is integrated electrode arrays as temperature sensors. The resistance of the electrode can be measured to measure the temperature. For example, temperature sensors around the coil can provide information about the degree of cooling and temperature sensors around the sample region can ensure that the temperature around the sample area is not affected by the cooling channel.

To prevent any loss coming from the tuning and matching network, bonding pads for the tuning and matching network can be microfabricated together with the surface coils. The microfluidic cryo-cooling channel(s) were designed to cool not only the surface coil but also the tuning and matching network. This can be extended to cryo-cool the pre-amplifier that can be also fabricated or integrated to the surface coils, which can maximize the sensitivity and minimize the noise.

Since the surface coils are cooled to liquid nitrogen temperature, water can condense and freeze on the surface coils. Although this itself will not have any effect on the MR imaging other than copper degradation over long term, the thin air gap can be affected by ice formation, hence affecting the temperature at the imaging surface. This can be overcome by either pumping nitrogen gas through the air gap or by capping the air gap in a nitrogen environment during fabrication to have a nitrogen gap instead of an air gap. This prevents any condensation and ice formation in the air gap.

In certain embodiments, the design described above can be expanded to arrays. Arrays of microfluidic channels, each incorporated underneath a coil, can be used to cool coil arrays simultaneously. For example, when using a 64 coil array for MRI imaging, 64 microfluidic channels can be built under each coil. Each fluidic channel can be connected to an external coolant source separately, but it is ideal to create a fluidic network on the system itself so that all the channels converge into a single channel, which can then be connected to an external coolant source. This can minimize the number of fluidic connecting required. FIG. 14 shows an illustration of such a system with 16 coil/cooling channel elements.

In certain embodiments, the design can be also realized in thin flexible layers, enabling the whole system to be bent around a non-planar target area or placed inside a circular target area, such as blood vessels, to minimize and maintain the distance between the coil and the target area.

In another embodiment, two types of microfluidic cryo-cooling channels can be fabricated. The first channel was fabricated with PDMS using a microfabrication technique called soft lithography. In this method, a mold was first microfabricated using a photosensitive polymer and conventional photolithography, followed by pouring and curing of liquid PDMS on the mold. The cured channel layer was released from the mold followed by bonding with a PDMS capping layer to create a fluidic channel. Once a mold is microfabricated, hundreds or thousands of polymer replicas can be stamped out easily in a short time. PDMS microchannels with width ranging from 100μm to 500μm and depth ranging from 30μm to 100μm have been fabricated. The second microfabrication method used was hot embossing of PMMA sheet against a metal mold. First, a nickel mold was microfabricated on a stainless steel plate by conventional photolithography and nickel electroplating. A PMMA sheet was placed on top of the nickel mold and heat and pressure was applied to stamp out the channel layer, followed by thermal bonding with a capping layer.

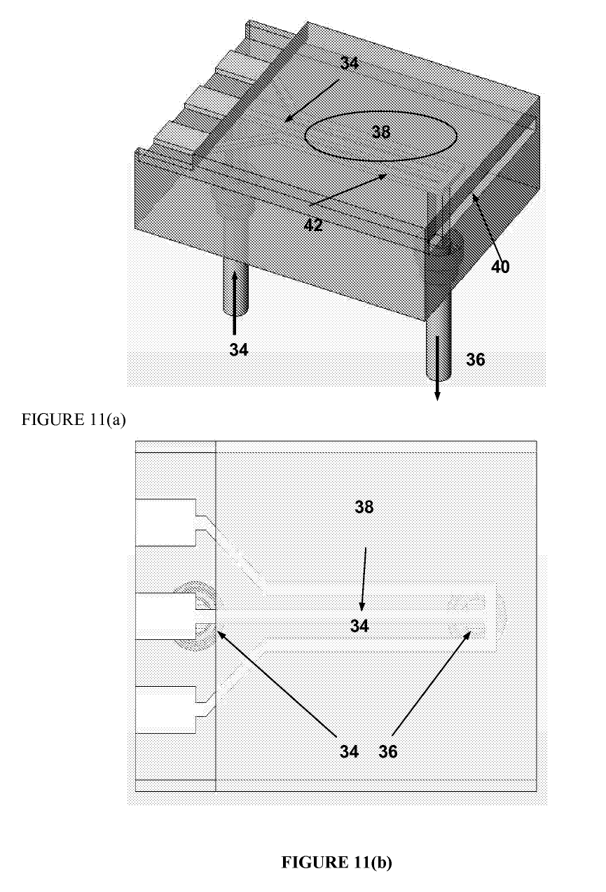

The simulation result from FIGS. 11(a) and 11(b) have shown before demonstrates that when a micrometer scale fluidic channel through which liquid nitrogen flows is placed directly underneath a MRI surface coil, the surface coil can be cooled down to liquid nitrogen temperature without affecting the temperature at the imaging surface. This is feasible due to the small volume of liquid nitrogen flowing through the microchannel (fluid inlet 34 and fluid outlet 36 in FIG. 11) and the thin air gap 38 between the surface coil 38 and the imaging surface 40 that limits direct heat transfer between the cold surface coil and the imaging surface. The air gap that separates the imaging surface from the surface coil and the thickness of the imaging stage has to be minimized to reduce the distance between the sensing coil and the target sample for maximum sensitivity. Initially, the system design shown in FIG. 1 were fabricated and characterized to validate the localized cryo-cooling of radiofrequency coils (e.g., MR microcoils).

The microfluidic cryo-cooling channel (42 in FIG. 11) placed underneath the surface coil will have widths ranging from 100 μm to 1 mm, depths of 30-80 μm, and lengths of 4-8 cm long to match the size of the surface coil electrode. From the simulation results, the size of a microfluidic cryo-cooling channel does not necessarily have to match the size of the surface electrode. A slightly narrower microfluidic channel compared to the width of the surface coil electrode is sufficient to cool the surface coil down to liquid nitrogen temperature. The thickness of the air gap will range from 100-500 μm.

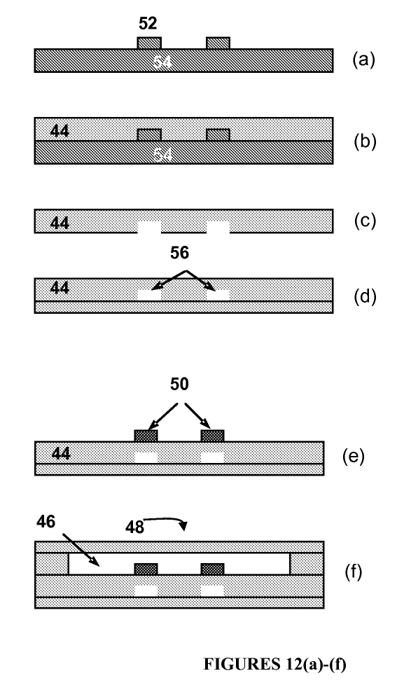

FIGS. 12(a)-12(f) show an example of the fabrication steps. The surface coil electrode may be fabricated on top of the PDMS or PMMA microfluidic channel as shown. A copper seed layer may be evaporated on top of the microfluidic channel followed by photolithography to create an electroplating mold to define the surface coil electrode. Copper can be electroplated to give proper thickness to the electrode followed by removing of the plating mold. The imaging surfaces may be fabricated in PDMS (44 in FIG. 12) or PMMA depending on the material used for the microfluidic channel. Soft lithography or hot embossing involved in this fabrication step defines the size of the air gap 46 and the thickness of the imaging surface 48. This imaging surface can be bonded on top of the microfluidic channel layer that already has the surface coil electrode 50 built on top of it. Plasma-activated bonding or thermal bonding already developed may also be used [60]. Epoxy mold 52 and silicon 54 may also be used as shown in FIG. 12(a). Cooling Channel 56 is formed as shown in FIG. 12(d).

PMMA microchannels take slightly longer to fabricate compared to PDMS microchannels, although both can be made in a matter of several hours. PMMA provides better structural support due to the rigid property whereas PDMS is a flexible material. The flexibility of PDMS can be utilized for future development of non-planar MR surface coils that are useful for imaging curved biological samples.

Once the design shown in FIG. 1 is fabricated and characterized, the cryo-cooling microchannel/surface coil system shown in FIG. 11 is fabricated and characterized. The exact dimensions of the surface coil to be built were based on the optimized modeling and simulation results. The system integrated bonding pads into which matching and tuning network can be dropped in. These pads were fabricated simultaneously when the surface coils are fabricated without any extra fabrication processes. Surface-mount scheme developed will be used [57]. The microfluidic channel will cool both the surface coils and the matching/tuning networks to liquid nitrogen temperature to avoid any loss resulting from wire bonding the surface coils to an external matching and tuning networks.

Temperature characterization of the cryo-cooled surface coil. The temperatures at the surface coil and the imaging surface of the fabricated system are the key parameters that have to be characterized first. Two methods were used to measure the temperature. First, a thermocouple is used by attaching it directly to the surface coil and the imaging surface and wrapping it with insulating foams. Continuous measurements were taken to observe the change in temperature over time while cooling. The second method is to measure the change in resistance of the surface electrode which can indicate the change in temperature, since copper shows a linear change in its resistivity over temperature [74]. To measure the temperature at the surface coil electrode, this electrode was simply connected to a digital multimeter (3458A, Agilent Technologies, Inc.) to measure its resistance. To measure the temperature at the imaging surface, an electrode was fabricated on top of the imaging surface using the same fabrication process used for making the surface coil electrode. This electrode works as a temperature sensor at the imaging surface.

A liquid nitrogen dewar is connected to the microfluidic channel to continuously supply liquid nitrogen through the channel. The liquid nitrogen will be driven either by applying pneumatic pressure into the dewar or by thermally generating pressure inside the dewar. The fabricated microdevice is tested and liquid nitrogen was successfully pumped through the microfluidic channels.

The most likely source of major challenge at this step is the liquid nitrogen evaporating while still being inside the microfluidic cooling channel. This is due to the small volume of liquid nitrogen flowing through the microfluidic channel. The gas-phase liquid nitrogen may have a significantly lower heat capacity, hence resulting in reduced cooling capability. A fast-enough flow ensures that liquid nitrogen stays in liquid phase while passing underneath the surface coils. The present inventors successfully pumped liquid nitrogen through the microfluidic channels in liquid phase by developing a fluidic interconnector that enables fast flowing of liquid nitrogen through some of the larger microfluidic channels. These fluidic connectors were tested on smaller microfluidic channels to minimize the temperature effect to the imaging surface and also to minimize liquid nitrogen consumption. Another alternative is to simply use a deeper microfluidic channel, increasing the overall volume of liquid nitrogen that can be pumped through. This can have a negative temperature effect on the imaging surface but can be solved by simply moving the horizontal location of the support structure for the imaging surface further away by or by adding localized heaters in the middle of the cold energy path. In the first approach, by moving the supporting structure for the imaging surface further away from the liquid nitrogen cooling channel the heat path from the cooling channel to the imaging surface is increased. In the second approach, an electrode can be placed at each end of the imaging surface through which a current can be applied to block the cold energy path. The temperature effect from the heater is localized as reported by Lin [75], with a similar principle as the cold temperature from the liquid nitrogen being localized. The current can be turned off right before the MR imaging is performed. The first approach is an easier alternative, although the overall size of the system does not become lager.

Another challenge of the present invention is water condensation in the air gap. Since the surface coils are cooled to liquid nitrogen temperature, water can condense and freeze on the surface coils. Although this itself does not have any effect on the MR imaging other than copper degradation over long term, the thin air gap can be affected by ice formation, hence affecting the temperature at the imaging surface. This can be overcome by either pumping nitrogen gas through the air gap or by capping the air gap in a nitrogen environment during fabrication to have a nitrogen gap instead of an air gap. This prevents any condensation and ice formation in the air gap.

Characterize the parameter space of conductor length and geometry (spiral number of turns, etc.) for a single coil. The significance of the present invention is that it can be integrated in various microcoil configurations and shapes, not just for a specific coil design. In general, the underlying microfluidic cooling channel may have the same shape as the microcoil.

To demonstrate the versatility of the proposed cooling system, the present invention can be designed and fabricated in various embodiments such as various shapes and sizes of microfluidic channels shown in FIG. 14, and be operated with liquid nitrogen. The various lengths, cross sections, number of turns, and spacing dimensions were based on the modeling performed. Fluidic channels with straight shapes and spiral shapes were fabricated and tested with liquid nitrogen to demonstrate the general application of such cryo-cooling channel. Limitations of the channel lengths and widths to successfully delivery liquid nitrogen were evaluated. These embodiments demonstrates more complicated coil systems since longer fluidic path corresponds to larger pressure drop and at some point, the liquid nitrogen will either change its phase to gas or a very high pressure will be required to maintain the liquid phase.

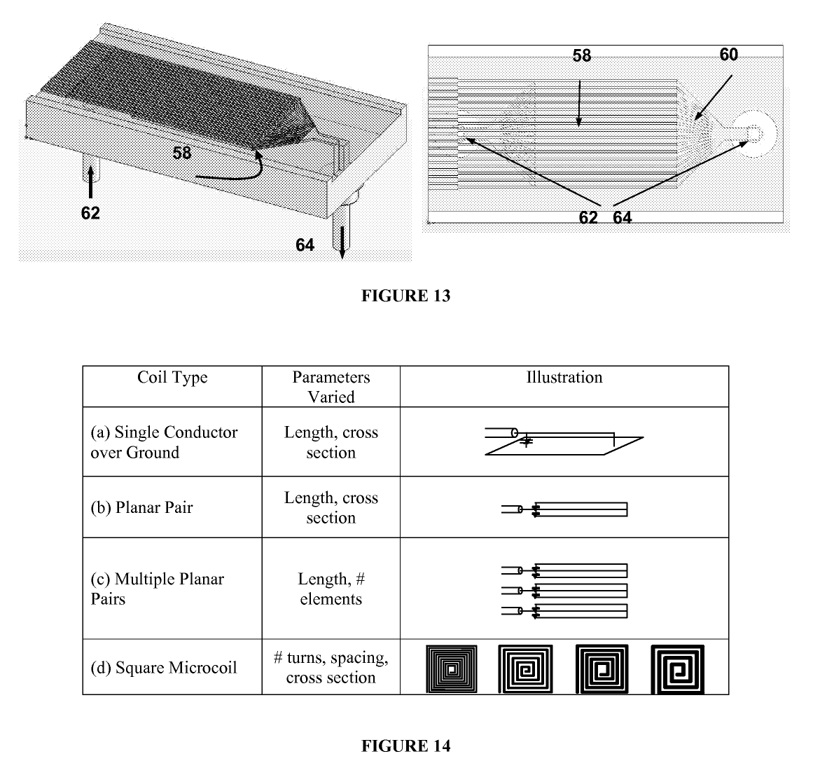

Characterize the ability to parallelize the system. FIG. 13 shows an example where 16 parallel cooling channels 60 are embedded under a surface coil array 58 with embedded parallel channels and liquid nitrogen inlet 62 and outlet 64. The ability to parallelize the cryo-cooling/surface coil system may be demonstrated. FIG. 14(a)-14(d) are a combined table and figures that summarize several design options for the present invention. For example, three planar pair surface coils as shown in FIG. 14(c) can be fabricated and the same number of cryo-cooling microfluidic channels embedded. All cooling channels may be connected to a single inlet and outlet. Liquid nitrogen pumping capability and the temperature profile were characterized as wells as coupling issues. Finally, fluidic cooling channels that have one inlet and one outlet with up to 64 parallel branched microfluidic channels were fabricated and tested with liquid nitrogen. Here, limitations of the numbers of parallel fluidic channels that can be used with single inlet/outlet were demonstrated.

Evaluate and optimize the performance of the integrated cryo-cooling channel/surface coil system using MRI. Single conductor parameters were modeled and optimized and be used for surface coil designs. Fabricated surface coils without cryo-cooling channels were tuned and matched, and the SNR versus depth were characterized. A corresponding cryo-cooled surface coil can be implemented and the SNR versus depth of the cryo-cooled and un-cooled surface coils may be characterized and compared. A phantom may be constructed and imaged using the 4.7 Tesla MRI. Coronal and axial images and the SNR maps were made according to NEMA standards, followed by numerical evaluation as required for FDA 510(k) approval of receive only surface coils.

Coils fabricated with and without the integrated cryo-cooling channels may be tested on the bench and on the 4.7 T scanner at the MRSL to provide comparison of both the effects of the cooling and any effects of the fabrication methods. In certain embodiments, different coil configurations may be modeled using software developed by the present inventors for SNR over the desired imaging planes and the results can be used to design the surface. The configurations that will be modeled are listed in FIG. 14. Initially single conductors over a ground plane may be used to validate the modeling of the single cryo-cooling channel performance. Initial data on the length and copper mass that can be effectively cooled may be used to develop initial coil designs. The coil may be placed over a ground plane for a current return path and matched and tuned. The planar pair element used by our group for SEA imaging may be fabricated in a smaller form factor. In order to create arrays of coils, the ability to cool many conductors simultaneously may be demonstrated. In order to verify that the cooling is successful, the same geometry may be fabricated in a multi-element format and the performance verified as described below. No difference in performance for the single element as characterized should be seen. Different spiral microcoils may be fabricated and tested, varying the number of turns, trace widths and spacings.

Construction and evaluation. Interface boards providing ground planes may be fabricated using the LPKF circuit prototyper. After construction, matching and tuning of coils, both cooled and uncooled, bench measurements of coil Q and resistance may be obtained before imaging performance characterization. Loaded and unloaded Q values may be obtained using the HP4195A and HP4395A network analyzers in the MRSL. Relative SNR can be determined either directly from measurements of the flux produced by the coil and the coil resistance or from the coil Q, as described in [76].

MRI based performance characterization. Following bench evaluation described above, each coil can be evaluated using a series of tests to evaluate the SNR and resolution performance. A phantom cab be constructed using various rapid prototyping tools. A MDX-40 subtractive rapid prototyping machine (Roland, Inc.) or a 3D rapid prototyping tool (Prodigy Plus, Stratasys , Inc.) in the College of Architecture, may be used. The present inventors have extensive experience in rapid prototyping of plastic parts [60,77]. The phantom can include a flood area for SNR evaluation, and a pin-cushion to assess resolution, and a contrast evaluation region containing three different concentrations of CuSO4 doped water. Coronal and axial images may be made at different depths from the array. SNR maps may be made according to NEMA standards, and resolution can be assessed using the resolution portion of phantom. Numerical evaluation will follow NEMA Standards MS 1 (single coil) as required for FDA 510(k) approval of receive only surface coils. For coils with integrated cryo-cooling, all measurements can be repeated with and without cryo-cooling.

In an embodiment, a microfluidic cryo-cooling channel can be integrated directly underneath or around the MRI/NMR coil. The microfluidic cryo-cooling channel is used to flow liquid nitrogen or liquid helium through to cool the temperature of the coil to or close to the temperature of liquid nitrogen or liquid helium. Cooling of the coil lowers the resistivity of the coil, hence resulting in improved SNR and reduced acquisition time. Incorporating the cryo-cooling channel directly underneath or around the coil enables the cooling of the coil without affecting the temperature of the target or sample region, which is typically located on top of the coil without being in direct contact with the coil. The small volume of liquid nitrogen or liquid helium carried through the microfluidic channel localizes the cooling effect. This is different from conventional cryostats, where the temperature of both the coil and target/samples are affected by liquid nitrogen or liquid helium unless a thick vacuum insulator is used to maintain the temperature of the target sample at the cost of larger coil to sample distance.

In certain embodiments, the present invention can be expanded to arrays of MR imaging coils/microfluidic cryo-cooling channels for parallel imaging/detection. Each channel can be either connected to the outside coolant source independently, or connected to a single inlet and outlet on chip and connected to the outside coolant source, requiring only one fluidic connection on each side (inlet and outlet). This latter microfluidic channel network enables cooling of all the coils simultaneously with a single inlet and outlet connection. The coils and microfluidic channels can be either fabricated together using microfabrication technologies or the microfluidic channel can be fabricated separately and be attached to a conventional coil. The integrated coil/microfluidic cyo-cooling channel system can be also built in both planar and non-planar form, which will allow the system to be in a cylindrical form for insertion into a blood vessel or to change to other non-planar shapes for imaging/detecting curved samples such as brain or blood vessels.

Several designs to realize the system have been developed and numerical simulations were conducted on various configurations, both in dimensions and structures, to test the concept. Various materials from high thermally conducting material to low thermally conducting materials have been used in simulation as the channel material and the imaging surface material. In certain embodiments, microfluidic cryo-cooling channels have been fabricated in various polymers such as polydimethyl siloxane (PDMS) and poly(methyl methacrylate) (PMMA) and successful pumping of liquid nitrogen through the channels has been achieved. The temperature profile is currently being measured.

Variation in different embodiments. 1) In certain embodiments, instead of placing the surface coil on top of the surface coil separated by a thin channel capping layer, the microcoil can be placed directly inside the microfluidic cryo-cooling channel. The microcoil can be microfabricated on the channel capping layer, flipped over, and bond to the channel layer so that channel capping and microcoil placement inside the microfluidic channel can be done in one process. Using this configuration, 100% efficiency can be achieved for cryo-cooling the microcoil since the microcoil is immersed directly inside liquid nitrogen. The thin air gap and imaging surface remains same. The microcoils can be connected to outside equipments using bonding pads or through-wafer conducting via.

2) Variation in the microfluidic channel size and spacing. In another embodiment, the size of the microfluidic channel width and depth in proportion to the coil size may be optimized. The effect of the gap between the microfluidic channel and the coil is also being investigated while considering the various microfabrication options and material thicknesses. In the array format, the microfluidic channel dimensions and the spacing between such channels are being optimized. Also, the best fluidic network configuration is being investigated to ensure simultaneous and uniform cooling of all the coils. Table 1 summarizes the types of cryo-cooled microcoil systems we are working on. The microfluidic cryo-cooling channel will either trace the shape of the microcoil or will be broad enough to cover the microcoil.

3) High-temperature superconducting material (HTS). Yet in another embodiment, the coil area can be fabricated using high temperature superconducting material (HTS) instead of copper. This can further improve the sensitivity of the system while reducing the acquisition time. HTS such as Y—Ba—Cu—O (YBCO) has a superconductivity with a transition between −193° C. (80K) and −180° C. (93K). At the so-called “zero-resistance” state, the resistivity of YBCO at liquid nitrogen temperature (0.03×10⁻⁸ Ωm) is almost 7 times more conductive then the resistivity of copper at liquid nitrogen temperature (0.215×10⁻⁸ Ωm). Microfabricated YBCO surface coil arrays with integrated cryo cooling system using microfluidics can enhance the SNR of the coil dramatically, hence enabling high-resolution real-time imaging of biological samples.

Briefly, the integrated coil/microfluidic cryo-cooling channel system enhances the SNR and reduce the acquisition time of MRI/NMR without affecting the temperature of the target samples, which can be of chemical or biological origin. This has advantages over conventional cryostat where both the coil and sample regions are cooled down together or a thick vacuum insulator has to be used to maintain the sample temperature. Arrays of such structure can be fabricated using microfabrication technologies, which enables batch fabrication at low cost and precision. The capability to build this system in thin, flexible substrate is extremely useful for imaging of non-planar samples, such as blood vessels or brain. Maintaining a uniform distance between the coil and the target ensures uniform image quality.

One of the significance of the present invention is that the resulting system provides critical tools for the current imaging needs, such as imaging small targets (e.g. single cells) by using high-density surface coil arrays or ultra-fast imaging for monitoring real-time physiological changes in biological samples such as blood vessels or brain slices. The developed microfluidic cryo-cooling technology is not limited to a specific surface coil configuration but can be applied broadly to various other planar and non-planar microcoil configurations. This invention can be expanded further to cool high temperature superconducting (HTS) surface coil arrays using liquid nitrogen to further improve scanning time without affecting the biological samples to be imaged.

The present invention includes an assembly for magnetic resonance imaging having a substrate with an imaging surface and an opening within the substrate adjacent the imaging surface. The assembly also has a magnetic resonance coil within the opening and opposite the imaging surface, a cryo-cooling via disposed within the substrate and below the magnetic resonance coil and opposite the imaging surface, and the via has an inlet and an outlet for a cryogenic fluid. The cryogenic fluid may cool the radiofrequency coil and the opening buffers the tissue target at or about the imaging surface from the cooling of the cryogenic fluid. The coils of the present invention may be in the form of an array. The substrate may have one or more sensors disposed within the vias and one or more valves, wherein the sensors detect the temperature as cryogenic fluid traverses the via and one or more processors open and close the valves depending on the temperature at the one or more sensors. Furthermore, at least one device layer of the substrate may be made out of, but are not limited to a polymeric material, a urethane polymer, an acrylic polymer, a fluoropolymer, a silicone, a silicone gel, an epoxy, a polyamide, or a polyolefin, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), polyvinylidene fluoride (PVDF) or any combinations thereof. The substrate of the present invention may also be made out of, but are not limited to, aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, cereated glass, or any combinations thereof. The assembly of the present invention may have an operating cryogenic fluid contacting at least a portion of the magnetic resonance coil. The assembly also has an enclosure disposed on or about the imaging surface, wherein the magnetic resonance coil is disposed substantially within the enclosure, and one or more tubes that connect the vias to a cryogenic fluid tank. The assembly also has a pump that actively flows cryogenic fluid through the vias. In certain embodiments, the assembly of the present invention is a superconducting magnetic resonance system. Yet in another embodiment, the assembly of the present invention is a magnetic resonance imaging apparatus with a plurality of a radiofrequency coil arrays.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Ramsey J M: The Burgeoning Power of the Shrinking Laboratory. Nature Biotechnology 1999;17:1061-1062.

2. Ramsey J M, Jacobson S C, Knapp M R: Microfabricated Chemical Measurement Systems. Nature Medicine 1995;1:1093-1096.

3. Moorthy J, Mensing G A, Kim D, Mohanty S, Eddington D T, Tepp W H, Johnson E A, Beebe D J: Microfluidic Tectonics Platform: A Colorimetric, Disposable Botulinum Toxin Enzyme-Linked Immunosorbent Assay System. Electrphoresis 2004;25:1705-1713.

4. Thorsen T, Maerkl S J, Quake S R: Microfluidic Large-Scale Integration. Science 2002;298:580-584.

5. Shoji S, Esashi M: Microflow Devices and Systems. Journal of Micromechanics and Microengineering 1994;4:157-171.

6. Gravesen P, Branebjerg J, Jnsen O S: Microfluidics—a Review. Journal of Micromechanics and Microengineering 1993;3:168-182.

7. Shaikh K A, Ryu K S, Goluch E D, Nam J-M, Liu J, Thaxton C S, Chiesl T N, Barron A E, Lu Y, Mirkin C A, Liu C: A Modular Microfluidic Architecture for Integrated Biochemical Analysis. Proceedings of the National Academy of Sciences of the United States of America 2005;102:9745-9750.

8. Choi J, Oh K, Thomas J H, Heineman W R, Halsall H, Nevin J H, Helmicki A J, Henderson H T, Ahn C H: An Integrated Microfluidic Biochemical Detection System for Protein Analysis with Magnetic Bead-based Sampling Capabilities. Lab Chip 2002;2:27-30.

9. Ahn C H, Choi J-W, Beaucage G, Nevin J H, Lee J-B, Puntambekar A, Lee J Y: Disposable Smart Lab on a Chip for Point-of-Care Clinical Diagnostics. Proceedings of the IEEE 2004;92:154-173.

10. Andersson H, Berg Avd: Microfluidic Devices for Cellomics: a Review. Sensors and Actuators B 2003;92:315-325.

11. Liu Y, Garcia C D, Henry C S: Recent Progress in the Development of uTAS for Clinical Analysis. The Analyst 2003; 128:1002-1008.

12. Sanders G H W, Manz A: Chip-Based Microsystems for Genomics and Proteomic Analysis. Trends in Analytical Chemistry 2000;19:364-378.

13. Bashir R: BioMEMS: State-of-the-art in Detection, Opportunities and Prospects. Advanced Drug Delivery Reviews 2004;56:1565-1586.

14. Polla D L, Erdman A G, Robbins W P, Markus D T, Diaz-Diaz J, Rizq R, Nam Y, Brickner H T: Microdevices in Medicine. Annu. Rev. Biomed. Eng. 2000:551-576.

15. Jr J T S, Cima M J, Langer R: A Controlled-Release Microchip. Nature 1999;397:335-338.

16. LaVan D A, McGuire T, Langer R: Small-Scale Systems for in vivo Drug Delivery. Nature Biotechnology 2003;21:1184-1191.

17. Chun K, Hashiguchi G, Toshiyoshi H, Fujita H: An Array of Hollow Microcapillaries for the Controlled Injection of Genetic Materials into Animal/Plant Cells. IEEE MEMS 1999 1999:406-411.

18. Reed M L, Lye W-K: Microsystems for Drug and Gene Delivery. Proceedings of the IEEE 2004;92:56-75.

19. McAllister D V, Allen M G, Prausnitz M R: Microfabricated Microneedles for Gene and Drug Delivery. Annu. Rev. Biomed. Eng. 2000:289-313.

20. Shawgo R S, Grayson A C R, Li Y, Cima M J: BioMEMS for Drug Delivery. Current Opinion in Solid State and Materials Science 2002;6:329-334.

21. Prausnitz M R: Microneedles for Transdermal Drug Delivery. Advanced Drug Delivery Reviews 2004;56:581-587.

22. Andersson H, Berg Avd: Microfabrication and Microfluidics for Tissue Engineering: State of the Art and Future Opportunities. Lab Chip 2004;4:98-103.

23. Borenstein J T, Terai H, King K R, Weinberg E J, Kaazempur-Mofrad M R, Vacanti J P: Microfabrication Technology for Vascularized Tissue Engineering. Biomedical Microdevices 2002;4:167-175.

24. Powers M J, Domansky K, Kaazempur-Mofrad M R, Kalezi A, Capitano A, Upadhyaya A, Kurzawski P, Wack K E, Stolz D B, Kamm R, Griffith L G: A Microfabricated Array Bioreactor for Perfused 3D Liver Culture. Biotechnology and Bioengineering 2002;78 :257-269.

25. Chovan T, Guttman A: Microfabricated Devices in Biotechnology and Biochemical Processing. Trends in Biotechnology 2002;20:116-122.

26. Jensen K F: Microreaction Engineering—Is Small Better? Chemical Engineering Science 2001;56:293-303.

27. Lee J-D, Yoon J-B, Kim J-K, Chung H-J, Lee C-S, Lee H-D, Lee H-J, Kim C-K, Han C-H: A Thermal Inkjet Printhead with a Monolithically Fabricated Nozzle Plate and Self-Aligned Ink Feed Hole. Journal of Microelectromechanical Systems 1999;8:229-236.

28. Mehra A, Zhang X, Ayon A A, Waitz I A, Schmidt M A, Spadaccini C M: A Six-Wafer Combustion System for a Silicon Micro Gas Turbine Engine. Journal of Microelectromechanical Systems 2000;9:517-527.

29. Jr. D H L, Janson S W, Cohen R B, Antonsson E K: Digital Micropropulsion. Sensors and Actuators A 2000;80:143-154.

30. Bar-Cohen A, Watwe A, Seetharamu K N: Fundamentals of Thermal Management. in Tummala R R (ed): Fundamentals of Microsystems Packaging. London: McGraw-Hill, 2001, 213-217.

31. Go J S, Kim S J, Lim G, Yun H, Lee J, Song I, park Y E: Heat Transfer Enhancement using Flow-Induced Vibration of a Microfin Array. Sensors and Actuators A 2001;90:232-239.

32. Jang S P, Kim S J, Paik K W: Experimental Investigation of Thermal Characteristics for a Microchannel Heat Sink Subjet to an Impinging Jet, using a Micro-Thermal Sensor Array. Sensors and Actuators A 2003;105:211-224.

33. Hung C E, Desmond C A, Ciarlo D R, Benett W J: Direct Bonding of Micromachined Silicon Wafers for Laser Diode Heat Exchanger Applications. Journal of Micromechanics and Microengineering 1991;1:152-156.

34. Wang Y, Yuan G, Yoon Y-K, Allen M G, Bidstrup S A: Active Cooling Substrates for Thermal Management of Microelectronics. IEEE Transactsactions on Components and Packaging Technologies 2005;28:477-483.

35. Tuckerman D B, Pease R F W: High-Performance Heat Sinking for VLSI. IEEE Electron Device Letters 1981;2:126-129.

36. Yokoyama Y, Takeda M, Umemoto T, Ogushi T: Thermal Micro Pumps for Loop-Type Micro Channel. Sensors and Actuators A 2004;1111:123-128.

37. Agarwal A K, Sridharamurthy S S, Beebe D J, Jiang H: An On-Chip Autonomous Microfluidic Cooling System. In The 13th International Conference on Solid-State Sensors, Actuators and Microsystems. Seoul, Korea, 2005:364-367.

38. Darabi J, Ohadi M M, DeVoe D: An Electrohydrodynamic Polarization Micropump for Electronic Cooling. Journal of Microelectromechanical Systems 2001; 10:98-106.

39. Wang E N, Zhang L, Jiang L, Koo J-M, Maveety J G, Sanchez E A, Goodson K E, Kenny T W: Micromachined Jets for Liquid Impingement Cooling of VLSI Chips. Journal of Microelectromechanical Systems 2004; 13 :833-842.

40. Darabi J, Wang H: Development of an Electrohydrodynamic Injection Micropump and Its Potential Application in Pumping Fluids in Cryogenic Cooling Systems. Journal of Microelectromechanical Systems 2005;14:747-755.

41. Wu M K, Ashburn J R, Torng C J, Hor P H, Meng R L, Gao L, Huang Z J, Wang Y Q, Chu C W: Superconductivity at 93K in a New Mixed-Phase Y—Ba—Cu—O Comound System at Ambient Pressure. Applied Review Letters 1987;58:908-910.

42. Hayes C, Axel L: Noise performance of surface coils for magnetic resonance imaging at 1.5 T. Med Phys 1985;12: p 604-607.

43. Hoult D I, Richards R E: The Signal-to-Noise Ratio of the Nuclear Magnetic Resonance Experiment. J. Magn. Reson. 1976;24:71-85.

44. Peck T L, Magin R L, Lauterbur P C: Design and Analysis of Microcoils for NMR Microscopy. Journal of Magnetic Resonacne B 1995; 108:114-124.

45. Balanis C A: Antenna Theory Analysis and Design. ed 2nd, New York, Wiley, 1997.

46. Grant S A, Bettencourt K, Krulevitch P, Hamilton J, Glass R: In Vitro and In Vivo Measurements of Fiber Optic and Electrochemical Sensors to Monitor Brain Tissue pH. Sensors and Actuator B 2001;72:174-179.

47. Song H K, Wehrli F W, Ma J: In vivo MR microscopy of the human skin. Magn Reson Med 1997;37:185-191.

48. Black R D, Roemer P B, Mueller O M: Electronics for a high temperature superconducting receiver system for magnetic resonance microimaging. IEEE Trans. Biomed. Eng 1994;41: 195-197.

49. Ginefri J, Darrasse L, Crozat P: High-Temperature Superconducting Surface Coil for In Vivo Microimaging of the Human Skin. Magnetic Resonance in Medicine 2001;45:376-382.

50. van Heteren J, James T, Bourne L: Thin film high temperature superconducting RF coils for low field MRI. Magn Reson Med 1994;32: p 396-400.

51. Ma Q, Chan K, Kacher D, Gao E, Chow M, Wong K, Xu H, Yang E, Young G, Miller J, Jolesz F: Superconducting RF coils for clinical MR imaging at low field. Acad Radiol 2003;10: p 978-987.

52. Wright A C, Song H K, Wehrli F W: In Vivo MR Micro Imaging with Conventional Radiofrequency Coils Cooled to 77K. Magnetic Resonance in Medicine 2000;43:163-169.

53. Wosik J, Wang F, Xie L M, Strikovski M, Kamel M, Nesteruk K, Bilgen M, Narayana P A: In Virginia Beach, Va., Institute of Electrical and Electronics Engineers Inc.:681-684.

54. Xue L, Xie L, Kamel M, Wosik J: On the SNR Gain for Copper and Superconductor Cryogenic Coils. In Proceedings 13th Scientific Meeting, International Society for Magnetic Resonance in Medicine. Seattle, 2006:2616.

55. Han A, Moss E, Rabbitt R D, Frazier A B: A Multi-Purpose Micro System for Electrophysiological Analysis of Single Cells. In Micro Total Analysis Systems (uTAS 2002). Nara, Japan, 2002:805-807.

56. Han K-H, Han A, Frazier A B: Microsystems for Isolation and Electrophysiological Analysis of Breast Cancer Cells from Blood. Biosensors and Bioelectronics 2006;21:1907-1914.

57. Choi J, Oh K W, Han A, Okulan N, Wijayawardhana C A, Lannes C, Bhansali S, Schlueter K T, Heineman W R, Halsall H B, Nevin J H, Helmicki A J, Henderson HT, Ahn C H: Development and Characterization of Microfluidic Devices and Systems for Magnetic Bead-Based Biochemical Detection. Biomedical Microdevices 2001;3:191-200.

58. Oh K W, Han A, Bhansali S, Ahn C H: A Low-temperature Bonding Technique using Spin-on Fluorocarbon Polymers to Assemble Microsystems. J. Micromech. Microeng. 2002;12:187-191.

59. Duffy D C, McDonald J C, Schueller O J A, Whitesides G M: Rapid Prototyping of Microfluidic Systems in Poly(dimethylsiloxane). Analytical Chemistry 1998;70:4974-4984.

60. Han A, Wang O, Graff M, Mohanty S K, Edwards T L, Han K-H, Frazier A B: Multi-Layer Plastic/Glass Microfluidic Systems containing Electrical and Mechanical Functionality. Lab Chip 2003;3:150-157.

McDougall M, Wright S M: Implementation of Single-Shot 3D Imaging Using the SEA Technique. In ISMRM 13th Scientific Meeting. Miami Beach, Fla., 2005:2418.

62. Wright S M, McDougall M, Yallapragada N: Rapid flow imaging using single echo acquisition MRI. In ISMRM 13th Scientific Meeting. Miami Beach, Fla., 2005.

63. Kurpad K, Boskamp E, Wright S M: RF Current Element Design for Independent Control of Current Amplitude and Phase in Transmit Phased Arrays. Concepts in Magnetic Resonance B 2006;(In Press).

64. McDougall M P, Wright S M: 64-Channel Array Coil for Single Echo Acquisition Magnetic Resonance Imaging. Magnetic Resonance in Medicine 2005;54:386-392.

65. Alison M R, Poulsom R, Forbes S, Wright N A: An Introduction to Stem Cells. Journal of Pathology 2002; 197:419-423.

66. Wright S, McDougall M, Yallapragada N: Ultra-Fast MR Velocity Measurement using Spin-Tagging and Single-Echo Acquisition (SEA) Imaging. In Proceedings 13th Scientific Meeting, International Society for Magnetic Resonance in Medicine. Seattle, 2006:203.

67. Gimi B, Leong T, Gu Z, Yang M, Artemov D, Bhujwalla Z M, Gracias D H: Self-Assembled Three Dimensional Radio Frequency (RF) Shielded Containers for Cell Encapsulation. Biomedical Microdevices 2005;7:341-345.

68. Webb C E: The Body Shops. IEEE Spectrum;February 2005:34-39.

69. Massin C, Vincent F, Homsy A, Ehrmann K, Boero G, Besse P-A, Daridon A, Verpoorte E, Rooij NFd, Popovic R S: Planar Microcoil-Based Microfluidic NMR Probes. Journal of Magnetic Resonance 2003; 164:242-255.

70. Subramanian V, Frechet J M J, Chang P C, Huang D C, Lee J B, Molesa S E, Murphy A R, Redinger D R, Volkman S K: Progress Toward Development of All-Printed RFID Tags: Materials, Processes, and Devices. Proceedings of the IEEE 2005;93:1330-1338.

71. Peck T L, Magin R L, Kruse J, Feng M: NMR microspectroscopy using 100 microns planar RF coils fabricated on gallium arsenide substrates. IEEE Trans Biomed Eng 1994;41:706-709.

72. Boyer J S: AN INVESTIGATION OF RECEIVER PROBE DEVELOPMENT FOR MAGNETIC RESONANCE MICROSCOPY. In Dept. of Electrical Engineering. College Station, Tex., Texas A&M University, 1995:141.

73. Spadea J R, Wright S M: Optimization of printed coil arrays for microscopic imaging and spectroscopy. Proceedings of the 19th Annual International Conference of the IEEE Engineering in Medicine and Biology Society, Oct. 30, 1997-Nov. 2, 1997;1:464-466.

74. Lide D R: CRC Handbook of Chemistry and Physics. ed 75th ed., Boca Raton, CRC Press, 1994.

75. Lin L: MEMS Post-Packaging by Localized Heating and Bonding. IEEE Transactions on Advanced Packaging 2000;23.

76. Boyer J S, Wright S M, Porter J R: An automated measurement system for characterization of RF and gradient coil parameters. J Magn Reson Imaging May-June 1998;+1998; 8:740-747.

77. Han A, Graff M, Wang O, Frazier A B: An Approach to Multilayer Microfluidic Systems with Integrated Electrical, Optical, and Mechanical Functionality. IEEE Sensors Journal 2005;5:82-89.

What is claimed is:

1. A magnet assembly for magnetic resonance coils comprising:
a magnetic coil comprising:
a substrate comprising an imaging surface,
an opening within the substrate adjacent the imaging surface,
an magnetic resonance coil within the opening; and
a cryo-cooling via disposed below magnetic resonance coil and the opposite the imaging surface, the via comprising an inlet and an outlet for a cryogenic fluid,
wherein the cryogenic fluid cools the radiofrequency coil and the opening buffers the tissue target at or about the imaging surface from the small heat capacity of microscale cryogenic fluid channel directly cooling the radiofrequency coil.

2. The assembly of claim 1, wherein the radiofrequency coils form an array.

3. The assembly of claim 1, wherein the cryogenic fluid cools the coil but not the imaging surface.

4. The assembly of claim 1, wherein the substrate further comprises one or more sensors disposed within the vias and one or more valves, wherein the sensors detect the temperature as cryogenic fluid traverses the via and one or more processors open and close the valves depending on the temperature at the one or more sensors.

5. The assembly of claim 1, wherein at least one device layer of the substrate comprises a polymeric material, a urethane polymer, an acrylic polymer, a fluoropolymer, a silicone, a silicone gel, an epoxy, a polyamide, or a polyolefin, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), or polyvinylidene fluoride (PVDF).

6. The assembly of claim 1, wherein the substrate comprises sapphire (Al₂O₃), LaAlO₃, (La, Sr)(Al,Ta)O₃ (LSAT), MgO, AlN, aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, or cereated glass.

7. The assembly of claim 1, wherein an operating cryogenic fluid contacts either directly or indirectly through a thin layer at least a portion of the magnetic resonance coil.

8. The assembly of claim 1, wherein further comprising an enclosure disposed on or about the imaging surface, wherein the magnetic resonance coil is disposed substantially within the enclosure.

9. The assembly of claim 1, further comprising one or more tubes that connect the vias to a cryogenic fluid tank.

10. The assembly of claim 1, further comprising a pump that actively flows cryogenic fluid through the vias.

11. The assembly of claim 1, wherein the cryogenic fluid comprises at least one of helium, hydrogen, carbon dioxide, argon, neon, and nitrogen.

12. The assembly of claim 1, wherein the coil comprises metal Cu, Nb or Nb compound such as NbTi or Nb₃Al, or lead alloy such as Pb or Pbln, or copper-oxide superconductor such as YBCO, or magnesium diboride (MgB₂).

13. A magnetic resonance system comprising:
a radiofrequency coil comprising:
a substrate comprising an imaging surface,
an opening within the substrate adjacent the imaging surface, wherein this longitudinal opening is also being used to pump through gas-phase, root temperature nitrogen gas to prevent water condensation;
a magnetic resonance coil array within the opening; and
a cryo-cooling via disposed below magnetic resonance coil and the opposite the imaging surface, the via comprising an inlet and an outlet for a cryogenic fluid,
wherein the cryogenic fluid cools the radiofrequency coil and the opening buffers the tissue target at or about the imaging surface from the cooling of the cryogenic fluid.

14. The assembly of claim 13, wherein the cryogenic fluid cools the coil but not the imaging surface.

15. The assembly of claim 13, wherein the cryo-cooling via form an array underneath each array format radiofrequency coil to minimize heat capacity

16. The assembly of claim 13, wherein the substrate comprises a polymeric material, a urethane polymer, an acrylic polymer, a fluoropolymer, a silicone, a silicone gel, an epoxy, a polyamide, or a polyolefin, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), or polyvinylidene fluoride (PVDF).

17. The assembly of claim 13, wherein the substrate comprises sapphire (Al₂O₃), LaAlO₃, (La, Sr)(Al,Ta)O₃ (LSAT), MgO, AlN, aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, or cereated glass.

18. The assembly of claim 13, wherein the coil comprises metal Cu, Nb or Nb compound such as NbTi or Nb₃Al, or lead alloy such as Pb or Pbln, or copper-oxide superconductor such as YBCO, or magnesium diboride (MgB₂).

19. The assembly of claim 13, wherein the substrate further comprises one or more sensors disposed within the vias and one or more valves, wherein the sensors detect the temperature as cryogenic fluid traverses the via and one or more processors open and close the valves depending on the temperature at the one or more sensors.

20. The assembly of claim 13, wherein at least one device layer of the substrate comprises a polymeric material having a low thermal conductivity to minimize the cold temperature from the cryogenic fluid reaching the imaging surface and affecting the imaging surface temperature.

21. The assembly of claim 13, wherein the cryogenic fluid contacts either directly or indirectly through a thin layer at least a portion of the magnetic resonance coil.

22. The assembly of claim 13, wherein further comprising an enclosure disposed on or about the imaging surface, wherein the magnetic resonance coil is disposed substantially within the enclosure.

23. The assembly of claim 13, further comprising one or more tubes that connect the vias to a cryogenic fluid tank.

24. The assembly of claim 13, further comprising a pump that actively flows cryogenic fluid through the vias.

25. The assembly of claim 13, wherein the cryogenic fluid comprises one of helium, hydrogen, carbon dioxide, argon, neon, and nitrogen.

26. An MRI apparatus comprising:
a plurality of a radiofrequency coil arrays, each of the arrays comprising:
a substrate comprising an imaging surface,
an opening within the substrate adjacent the imaging surface,
an magnetic resonance coil within the opening; and
a cryo-cooling via disposed below magnetic resonance coil and the opposite the imaging surface, the via comprising an inlet and an outlet for a cryogenic fluid,
wherein the cryogenic fluid cools the radiofrequency coil and the opening buffers the tissue target at or about the imaging surface from the cryogenic fluid.

27. A method of generating a MRI image comprising:
detecting a target image with an MRI apparatus comprising:
a magnetic coil comprising:
a substrate comprising an imaging surface,
an opening within the substrate adjacent the imaging surface,
an magnetic resonance coil within the opening; and
a cryo-cooling via disposed below magnetic resonance coil and the opposite the imaging surface, the via comprising an inlet and an outlet for a cryogenic fluid,
wherein the cryogenic fluid cools the radiofrequency coil and the opening buffers the tissue target at or about the imaging surface from the small heat capacity of microscale cryogenic fluid channel directly cooling the radiofrequency coil.
